(19) United States
(12) Patent Application Publication
(10) Pub. No.: US 2006/0030024 A1
(43) Pub. Date: Feb. 9, 2006

(54) Start-up method for filtering membranes to remove glycerin

(76) Inventors: Daryl Clayton Francis Wilson, Carlisle (CA); Jeffrey Peter Penny, Grimsby (CA)

Correspondence Address: BERESKIN AND PARR, 40 KING STREET WEST, BOX 401, TORONTO, ON, M5H 3Y2, CA

(21) Appl. No.: 11/185,773

(22) Filed: Jul. 21, 2005

Related U.S. Application Data
(60) Provisional application No. 60/598,429, filed on Aug. 4, 2004.

(51) Int. Cl. C02F 3/34; C02F 1/02

(52) U.S. Cl. 435/262; 210/600

(57) ABSTRACT

In a process for biodegrading glycerin used to store or preserve membranes, water in a tank is inoculated with glycerin digesting microorganisms. The water is aerated to support growth of the microorganisms. The water is filtered through the membranes and the filtrate returned to the tank. The glycerin is rinsed out of the membranes and biodegraded in the tank. The process may be performed in-situ in a water or wastewater treatment plant as part of the start-up procedures for the plant.

This is an application claiming the benefit under 35 USC 119 (e) of U.S. Ser. No. 60/598,429 filed on Aug. 4, 2004. Application Ser. No. 60/598,429 is incorporated herein, in its entirety, by this reference to it.

### FIELD OF THE INVENTION

This invention relates to water or wastewater treatment using filtering membranes.

### BACKGROUND OF THE INVENTION

Filtering membranes are often stored in glycerin to prevent the membranes from drying out and to facilitate re-wetting. The glycerin must be rinsed out and disposed of as part of plant start-up. The rinse water must either be discharged into a sewer, trucked away or destroyed on site, for example by advanced oxidation, none of which are practical or desirable methods.

### SUMMARY OF THE INVENTION

It is an object of the invention to improve on the prior art. It is another object of the invention to provide a process or apparatus for biodegrading glycerin used to preserve or store filtering membranes. The following summary is intended to introduce the reader to the invention, but not to define it. The invention may reside in a combination or sub-combination of elements or steps provided in this summary or in other parts of this document.

In one aspect, the invention provides a process for biodegrading glycerin from filtering membranes stored or preserved in the glycerin. A tank is filled with water and the water is inoculated with a source of glycerin digesting bacteria. Air is provided continuously or intermittently to the tank. The water in the tank is filtered, continuously or intermittently, through the filtering membranes. Glycerin is rinsed from the membranes and becomes part of the filtrate. The filtered water and glycerin are returned to the tank. Filtration continues until the glycerin has been biodegraded to the point where the TOC in the tank is below an acceptable level. The tank may be a tank that will be used as part of a water or wastewater treatment facility using the membranes. In this way, the glycerin may be biodegraded on-site and in-situ as part of the start-up procedures for the plant. For a membrane bioreactor or wastewater treatment plant, sewage may be used as the inoculum. In a drinking water plant, a seeding of non-toxic bacteria is used as the inoculum.

### BRIEF DESCRIPTION OF THE DRAWINGS

An embodiment of the invention will be described with reference to the following figure:

FIG. 1 is a schematic representation of a water or wastewater treatment system.

### DETAILED DESCRIPTION OF EMBODIMENT(S)

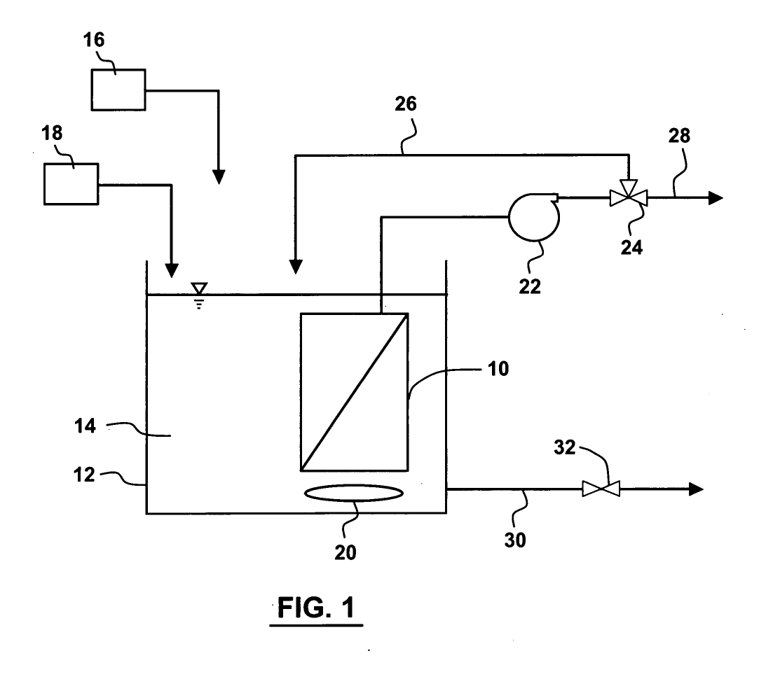

Referring to FIG. 1, a membrane unit 10 has membranes that have been stored in glycerin. The membrane unit 10 is immersed in a tank 12 which may be part of a water or wastewater treatment plant that will use the membrane unit 10. The tank 12 is filled with tank water 14 from a source of raw water 16 to immerse the membrane unit 10. The water 14 is then inoculated with glycerin digesting bacteria from a source of inoculating bacteria 18. The inoculating bacteria could be raw wastewater, if the tank 12 is part of a wastewater treatment plant, or could be dried bacteria, if the tank 12 is part of a drinking water plant. While biodegrading the glycerin, an aerator 20 is operated continuously or intermittently to supply oxygen to the tank water 14 to support the growth of the bacteria. For example, the aerator 20 may be operated to provide a dissolved oxygen concentration of between 1-2 mg/L in the tank water 14. The aerator 20 may also provide scouring bubbles to inhibit fouling of the membrane unit 10.

The permeate side of the membrane unit 10 is connected to a permeate pump 22 which flows permeate to a three-way valve 24. The three-way valve 24 may operate to flow the filtrate either to a filtrate recycle conduit 26 or a filtrate production conduit 28. A reject line 30 with a reject valve 32 may be used to drain the tank 12.

While biodegrading the glycerin, reject valve 32 is closed and three-way valve 24 is configured to flow filtrate to the filtrate recycle conduit 26. The permeate pump 22 is operated continuously or intermittently to provide closed circuit filtration. Glycerin in the membrane unit is rinsed into the filtrate and returned to the tank water 12. In the tank 12, the glycerin is biodegraded by the bacteria. The aerator 20 and permeate pump 22 are operated until the glycerin has been biodegraded to an acceptable degree. This may occur when the TOC of the tank water 14 is 100 mg/L or less although, depending on the jurisdiction and application, the maximum acceptable TOC may be, for example, between 2 and 100 mg/L

When an acceptable level of glycerin remains, the reject valve 32 may be opened to drain the tank water 14 from the tank. The tank 12 may then be re-filled and the apparatus configured for use for treating water. In particular, the three-way valve 24 may be configured to flow filtrate to the filtrate production conduit 28 and the source of raw water 16, permeate pump 22, reject valve 32 and aerator 20 and other system components may be operated as desired. Alternately, and particularly where the tank 12 will be part of a wastewater treatment plant operated with a continuous bleed of reject, the tank 12 does not need to be drained and re-filled when the amount of residual glycerin reaches an acceptable level. Instead, the reject valve 32 may be opened to provide a bleed of reject, and the source of raw water 16, aerator 20, permeate pump 22, three-way valve 24 and any other system components operated as required to immediately configure the apparatus for production. The remaining glycerin is rejected, permeated or further decomposed over time.

The invention may be practiced with modifications or in various alternate embodiments. For example, but without limitation, the invention may be practiced with the membranes located in a tank other than the aerated tank with an outlet for the aerated tank connected to an inlet of the membrane tank. The invention may also be practiced with pressure driven rather than immersed membranes.

We claim:

1. A process for removing glycerin used to store or preserve a filtering membrane from the membrane comprising the steps of:
a) filling a tank with water;
b) inoculating the tank with a bacteria that digests glycerin;
c) providing oxygen to the water in the tank to support the growth of the bacteria;
d) filtering the water in the tank through the filtering membrane; and,
e) returning the filtered water to the tank
wherein steps c), d) and e) are performed until a portion of the glycerin has been biodegraded.

2. The process of claim 1 wherein steps c), d) and e) are performed continuously or repeatedly until the glycerin has been biodegraded sufficiently to reduce the TOC of the water to 100 mg/L or less.

3. The process of claim 1 wherein the tank is a part of a water or wastewater treatment plant that will use the filtering membranes.

4. The process of claim 2 wherein the tank is a part of a water or wastewater treatment plant that will use the filtering membranes.
